(19) United States
(12) Patent Application Publication
(10) Pub. No.: US 2008/0197243 A1
(43) Pub. Date: Aug. 21, 2008

(54) Coupler for Cable Trough

(75) Inventor: Ronald A. Beck, St. Paul, MN (US)

Correspondence Address: MERCHANT & GOULD PC, P.O. BOX 2903, MINNEAPOLIS, MN, 55402-0903, US

(73) Assignee: ADC TELECOMMUNICATIONS, INC., Eden Prairie, MN (US)

(21) Appl. No.: 11/677,193

(22) Filed: Feb. 21, 2007

(51) Int. Cl. F16L 3/26

(52) U.S. Cl. 248/73

(57) ABSTRACT

Elements, couplers, systems, and methods for joining two or more trough members. A locking element for a coupler of a cable trough system can include a handle member, a threaded member, and a U-shaped member including first and second arms each defining points, the U-shaped member defining an aperture sized to receive the threaded member. The threaded member is coupled to the coupler, and the handle member is rotated to move the U-shaped member in a first direction to cause at least one of the first and second arms of the U-shaped member to contact an exterior surface of a trough member of the cable trough system to lock the trough member to the coupler.

### RELATED APPLICATIONS

This application is related to the following applications: U.S. patent application Ser. No. ______ (Attorney Docket No. 02316.2422US01); U.S. patent application Ser. No. ______ (Attorney Docket No. 02316.2423US01); U.S. patent application Ser. No. ______ (Attorney Docket No. 02316.2424US01); U.S. patent application Ser. No. ______ (Attorney Docket No. 02316.2426US01); U.S. patent application Ser. No. ______ (Attorney Docket No. 02316.2427US01), and U.S. patent application Ser. No. ______ (Attorney Docket No. 02316.1665US01), all of which were filed on even date herewith and are incorporated by reference herein.

### TECHNICAL FIELD

Embodiments disclosed herein relate to systems for the management and routing of telecommunication cables, and, more particularly, to couplers for joining trough members.

### BACKGROUND

In the telecommunications industry, optical fiber systems are increasingly used for high-speed signal transmission. With the increased utilization of optical fiber systems, optical fiber cable management requires industry attention.

One area of optical fiber management is the routing of optical fibers from one piece of equipment to another. For example, in a telecommunications facility, optical fiber cables are routed between fiber distribution equipment and optical line terminating equipment. In buildings and other structures that carry such equipment, the cable routing typically takes place in concealed ceiling areas or in other manners to route cables from one location to another.

When routing optical fibers and other cables such as copper wires, it is desirable that a routing system is readily modifiable and adaptable to changes in equipment needs. Accordingly, such routing systems include a plurality of components, such as trough members and couplers, for defining the cable routing paths. The trough members are joined together by couplings. U.S. Pat. Nos. 5,067,678; 5,316,243; 5,752,781; 6,709,186; and 6,715,719 teach cable routing systems that include a plurality of trough members and couplers.

Various concerns arise with the use of couplers for coupling trough members. One concern is that a plurality of hardware is used for joining the trough members. This hardware can be cumbersome. Further, there is sometimes a need to rearrange or change the trough members and couplers. It is desirable to provide couplers that can be disconnected and reconnected.

### SUMMARY

Embodiments disclosed herein relate to a system for the management and routing of telecommunication cables, and, more particularly, to elements, couplers, systems, and methods for joining two or more trough members.

One aspect relates to a locking element for a coupler of a cable trough system, the locking element including a handle member, a threaded member, and a U-shaped member including first and second arms each defining points, the U-shaped member defining an aperture sized to receive the threaded member. The threaded member is coupled to the coupler, and the handle member is rotated to move the U-shaped member in a first direction to cause at least one of the first and second arms of the U-shaped member to contact an exterior surface of a trough member of the cable trough system to lock the trough member to the coupler.

### DESCRIPTION OF THE DRAWINGS

FIG. 1 is a perspective view of an embodiment of a trough system shown in exploded form.

FIG. 2 is a perspective view of an embodiment of a coupler of the trough system of FIG. 1.

FIG. 3 is a side cross-sectional view of an embodiment of a locking element of the coupler of FIG. 2.

FIG. 4 is a side view of a U-shaped member of the locking element of FIG. 3.

FIG. 5 is a top view of the U-shaped member of FIG. 4.

FIG. 6 is a side view of a handle member of the locking element of FIG. 3.

FIG. 7 is a bottom view of the handle member of FIG. 6.

FIG. 8 is a side view of a threaded member of the locking element of FIG. 3.

FIG. 9 is a side view of a spring of the locking element of FIG. 3.

FIG. 10 is a perspective view of a trough member of the trough system of FIG. 1

FIG. 11 is a perspective view of another embodiment of a trough system.

FIG. 12 is a top cross-sectional view of a portion of a coupler with trough members in an inserted position and a locking element in a locked position.

FIG. 13 is a top cross-sectional view of the portion of the coupler of FIG. 12 with the locking element in an unlocked position.

### DETAILED DESCRIPTION

As used herein, the terms “couple” and “coupled” mean to join or attach a first element in relation to a second element, whether the attachment is made directly with the second element or indirectly through one or more intermediate components. As used herein, the term “slot” means a space defined by one or more surfaces and can include, without limitation, T-slots, closed slots, flanges, and projections.

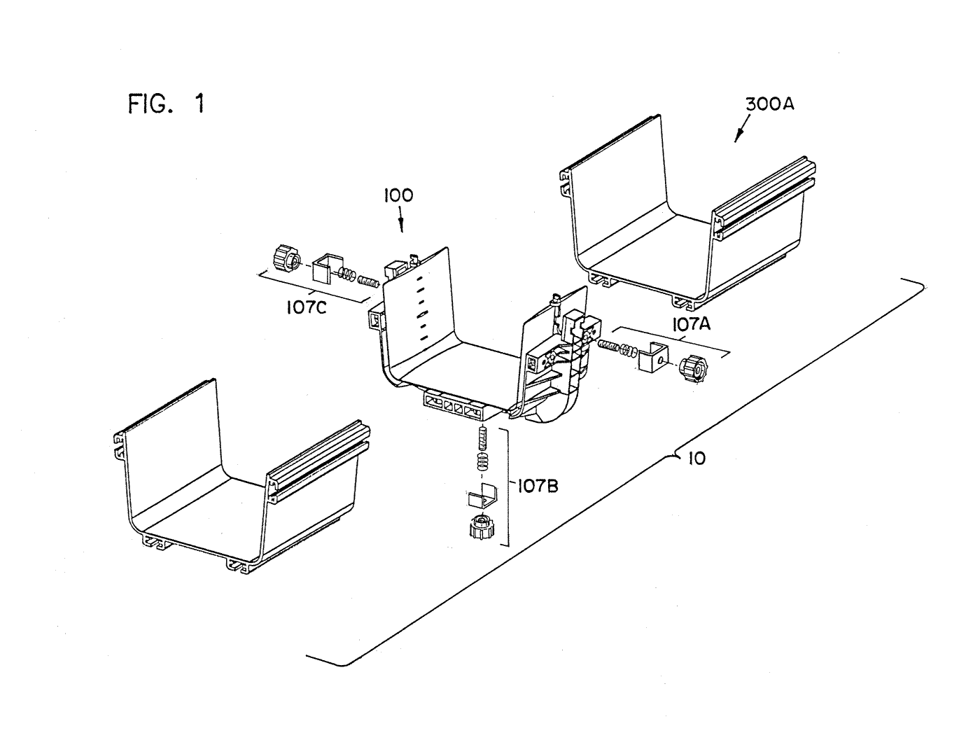

FIG. 1 shows an example trough system 10 including a coupler 100 for interconnecting trough members 300A, 300B. Coupler 100 includes locking elements 107A, 107B, 107C that secure the connection between coupler 100 and trough members 300A, 300B.

In addition, coupler 100 can be configured to release the connections between coupler 100 and trough members 300A, 300B. In an example embodiment, locking elements 107A, 107B, 107C are tool-less (i.e., do not require the use of a separate tool to couple and uncouple trough members 300A, 300B to coupler 100). However, elements requiring one or more auxiliary tools are also within the scope of the present disclosure.

### I. Coupler

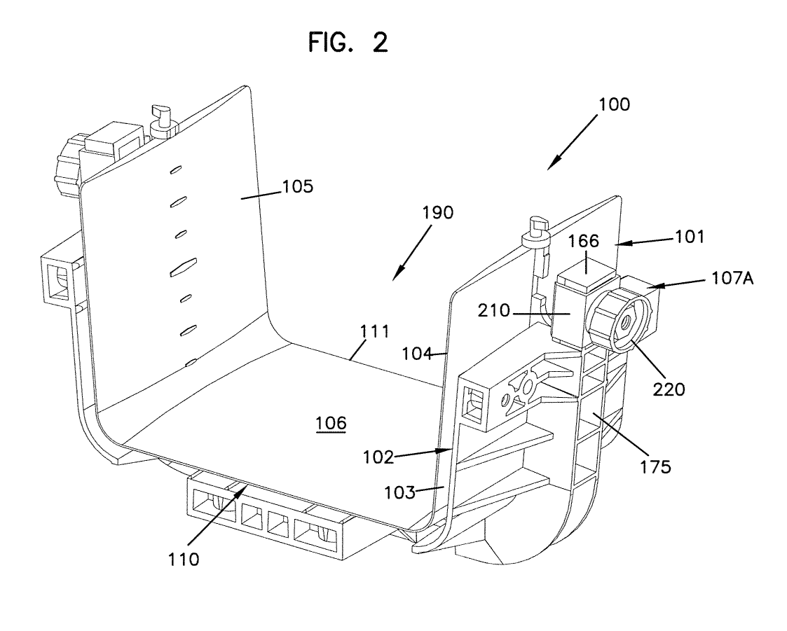

As shown in FIG. 2, coupler 100 includes a first guiding surface 101 and a second guiding surface 102 at least partially surrounding first guiding surface 101, as well as a first coupler end 110 and a second coupler end 111. A spacing 103 is defined between first guiding surface 101 and second guiding surface 102. Spacing 103 is sized to receive a trough member (e.g., trough members 300A, 300B) or another trough system component inserted into the spacing 103 in a longitudinal direction 190.

First guiding surface 101 of coupler 100 is generally in the shape of a trough, including a first side wall portion 104 and a second side wall portion 105, as well as a bottom wall portion 106 joining first and second side wall portions 104 and 105. As used herein, the term “trough” means any structure that defines an interior in which an element such as an optical cable can be maintained. Second guiding surface 102 is also in the shape of a trough. A midpoint or midsection 175 divides coupler 100 into first and second halves, and generally surrounds at least a portion of first guiding surface 101. A rib portion 166 is coupled to second guiding surface 102. Locking element 107A is coupled to rib portion 166, as described below.

Referring now to FIGS. 2-9, locking element 107A includes a U-shaped member 210, a handle member 220, a threaded member 230, and a spring 240.

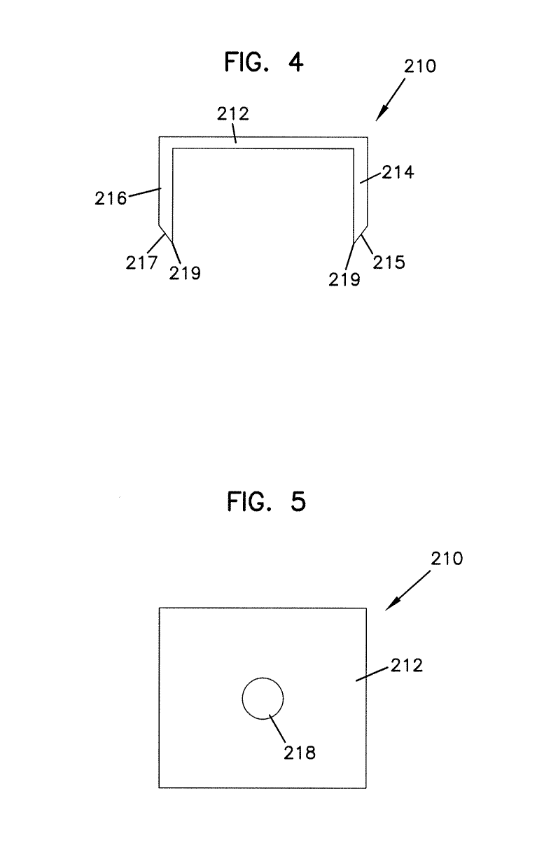

As shown in FIGS. 4 and 5, U-shaped member 210 includes a main portion 212 and arm portions 214, 216 extending therefrom to generally form a “U” shape. Ends 215, 217 of arm portions 214, 216 are formed to points 219 to engage outer surfaces of trough members inserted into coupler 100, as described below. Main portion 212 includes an aperture 218 sized to allow threaded member 230 to extend therethrough.

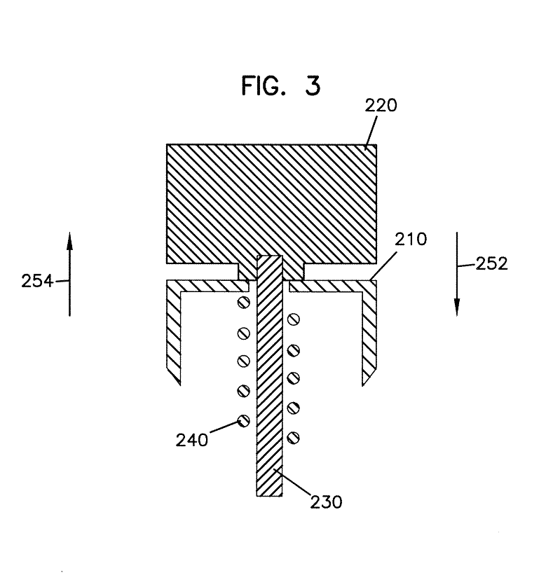

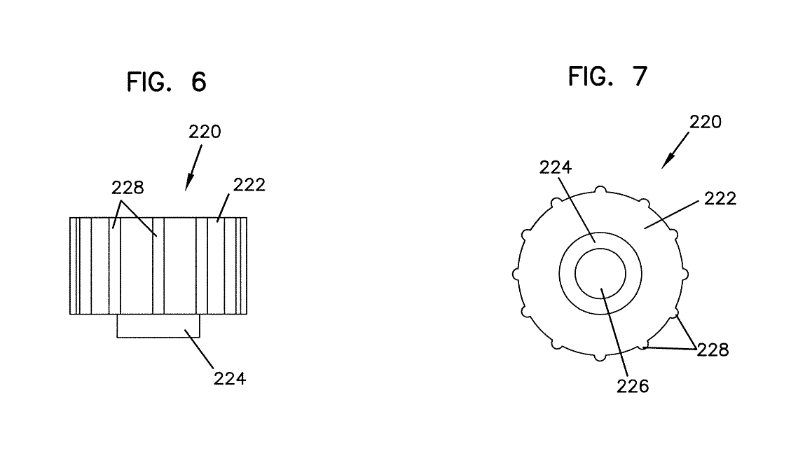

As shown in FIGS. 6 and 7, handle member 220 includes a main body 222 and a boss portion 224 coupled to the main body 222. Main body 222 and boss portion 224 include a threaded aperture 226 extending therethrough to allow handle member 220 to be threaded onto threaded member 230, as described below. In example embodiments, ribs 228 are formed on an outer surface of main body 222 to allow the user to grasp and rotate handle member 220 when threading onto and unthreading from threaded member 230. Boss portion 224 is sized to space main body 222 away from U-shaped member 210 when handle member 220 is in contact with U-shaped member 210 (see FIG. 3) to allow a user to easily grasp and rotate main body 222.

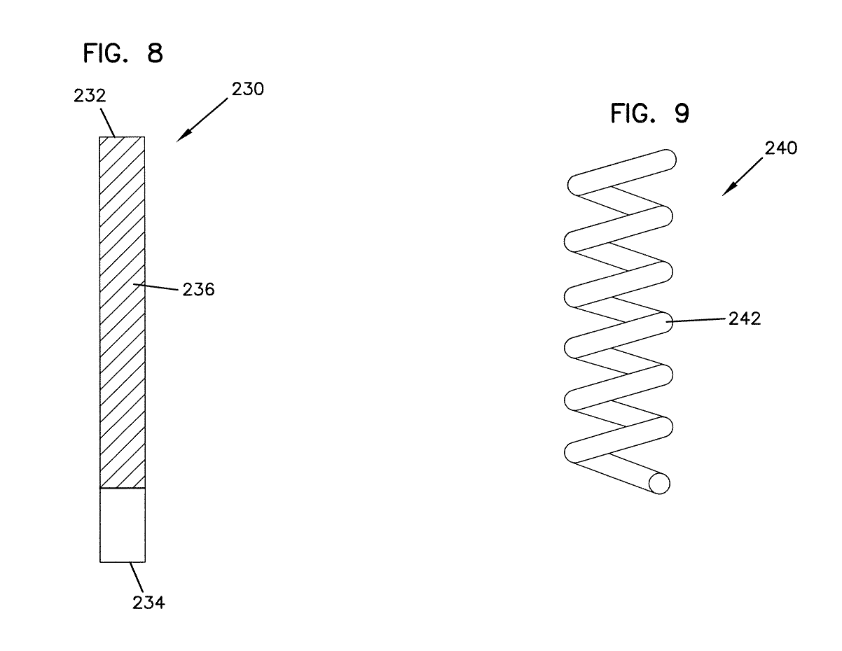

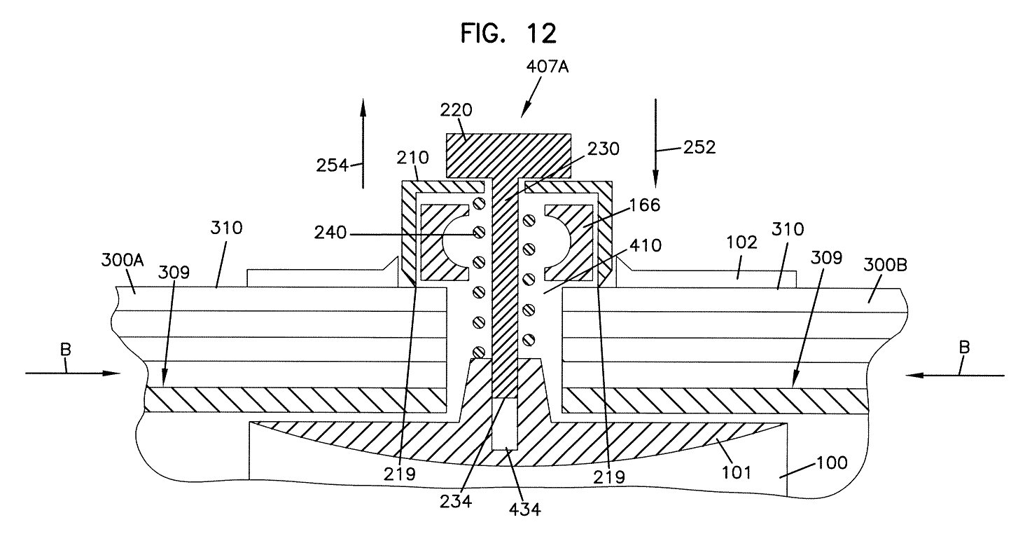

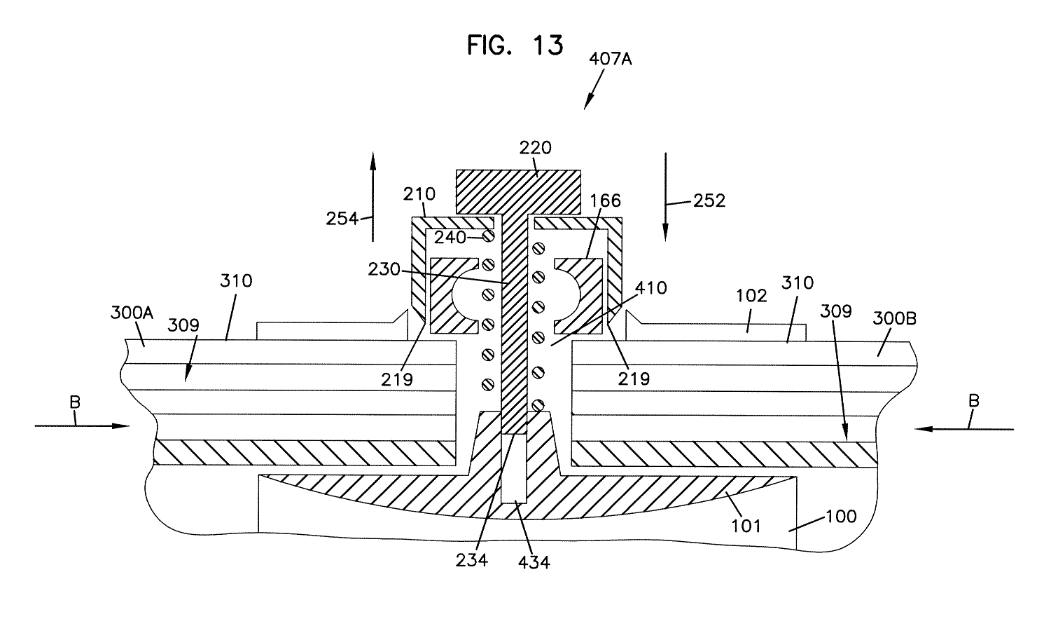

As shown in FIG. 8, threaded member 230 includes first and second ends 232, 234, and a portion 236 that is threaded to receive handle member 220 onto first end 232. In example embodiments, only a portion 236 of threaded member 230 is threaded. In alternative embodiments, the entirety of threaded member 230 can be threaded. In the example shown, second end 234 is coupled to a portion of coupler 100, such as second guiding surface 102. For example, second end 234 of threaded member 230 can be coupled to coupler 100 by threading second end 234 of threaded member 230 into an aperture formed by portion 166 of coupler 100. In alternative embodiments, threaded member 230 can be formed as part of handle member 230 (see FIG. 12). Other configurations are possible.

As shown in FIG. 9, spring 240 includes a main body 242 formed as a coil. In example embodiments, spring 240 is a compression spring, although other types of springs can be used. Spring 240 is positioned to push U-shaped member 210 away from coupler 100 and against handle member 220 (see FIG. 3). In alternative embodiments, spring 240 need not be included as part of locking element 107A.

Referring again to FIG. 3, spring 240 is positioned about threaded member 230, and U-shaped member 210 is positioned so that threaded member 230 extends through aperture 218 of U-shaped member 210 and contacts spring 240. Handle portion 220 is threaded onto first end 232 of threaded member 230. As handle member 220 is rotated in a clockwise direction to thread handle portion further onto threaded member 230, handle member 220 moves in a direction 252. As handle member 220 moves in direction 252, handle member 220 forces U-shaped member 210 to move in direction 242 against the force exerted by spring 240. As described further below, as U-shaped member 210 is forced in direction 252, points 219 of U-shaped member engage exterior surfaces of trough members 300A, 300B to retain trough members 300A, 300B in coupler 100. This is referred to as a locked position.

Handle member 220 can also be rotated in an opposite counterclockwise direction to move handle member in a direction 254 opposite to that of direction 252. As handle member 220 moves in direction 254, spring 240 forces U-shaped member 210 in direction 254 as well. As U-shaped member 210 moves in direction 254, points 219 of U-shaped member disengage exterior surfaces of trough members 300A, 300B to allow trough members 300A, 300B to be removed from coupler 100. This is referred to as an unlocked position.

In example embodiments, handle member 220 of locking element 107A can be rotated without the use of tools (i.e., by hand) so that locking element 107A can be moved from locked to unlocked positions and vice versa. In alternative embodiments, a tool can be used.

### II. Trough

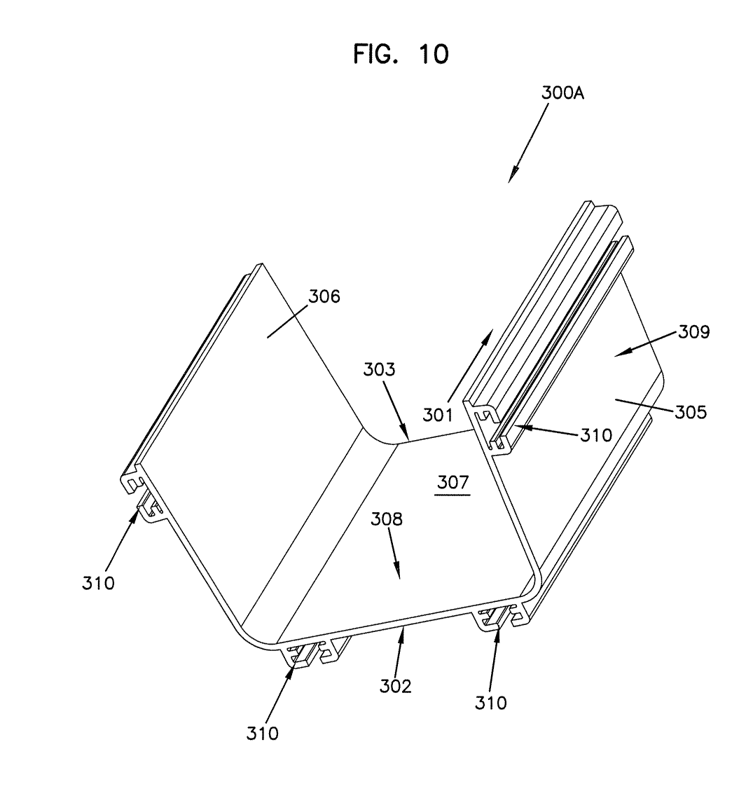

Referring now to FIG. 10, trough member 300A is shown in more detail. As used herein, the phrase “trough member” is used to refer to any trough, fitting, railway, raceway, or similarly configured component including any number of ends. Although a specific embodiment of a trough member is shown in and described herein, other trough members can also be used.

Trough member 300A includes a first terminal end 302 and a second terminal end 303. Trough member 300A is generally in the shape of a trough including first and second side walls 305, 306 coupled by a bottom wall 307, thereby defining an interior surface 308 and an exterior surface 309. Walls 305, 306, 307 are each generally planar. In example embodiments, exterior surface 309 of trough member 300A defines one or more slots 310 on the side walls 305 and 306 and bottom wall 307.

### III. System

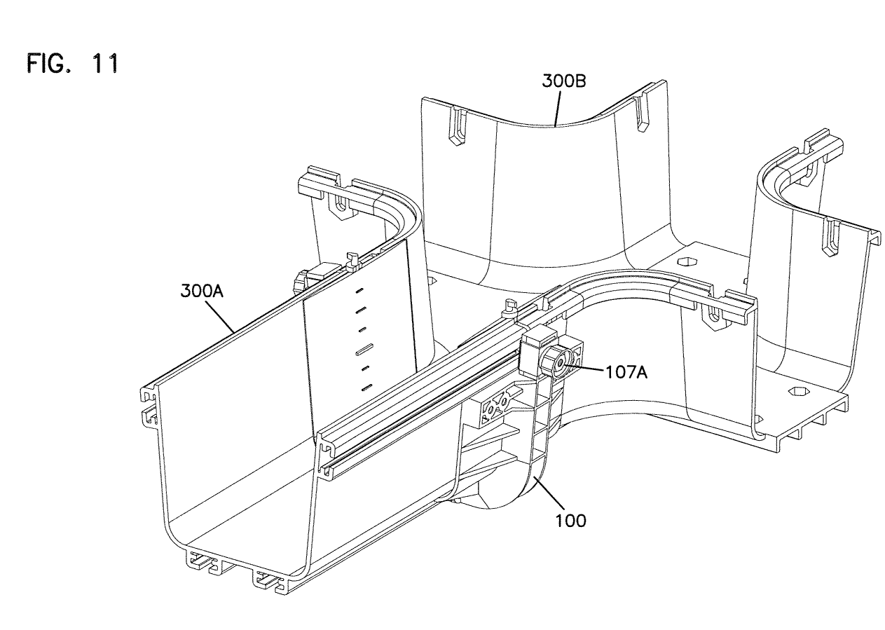

Referring now to FIGS. 11-13, one of terminal ends 302, 303 of the trough members 300A, 300B are slidingly engaged in a direction B within the spacing 103 between the first and second guiding surfaces 101 and 102 of coupler 100. The thickness of the walls of each of trough members 300A, 300B, or the distance between interior and exterior surfaces 308, 309, are sized to fit within spacing 103 of coupler 100. Coupler 100 overlaps terminal ends 302, 303 of each of trough members 300A, 300B to form the coupling, the overlap defining an overlap region.

Referring now to FIG. 12, another embodiment of a locking element 407A is shown attached to coupler 100. Locking element 407A is similar to locking element 107A described above, except that threaded member 230 is coupled to head member 220. A second end 234 of threaded member 230 is threaded into an aperture 434 defined by first guiding surface 101 of coupler to couple threaded member 230 and head member 220 to coupler 100.

Locking element 407A is shown in FIG. 12 in the locked position. In the locked position, head member 220 is rotated in the clockwise direction to thread threaded member 230 in direction 252 into aperture 434 of coupler 100 until points 219 of U-shaped member 210 engage slot 310 of trough members 300A, 300B. In this locked position, points 219 dig into slot 310 of trough members 300A, 300B to resist movement of trough members 300A, 300B in a direction opposite of direction B out of coupler 100.

As shown in FIG. 13, to release trough members 300A, 300B, head member 420 of locking element 407A is rotated in the clockwise direction to unthread threaded member 230 in direction 254 out of aperture 434 of coupler 100. As head member 420 moves in direction 254, spring 240 forces U-shaped member 210 in direction 254 as well until points 219 of U-shaped member 210 disengage slots 310 of trough members 300A, 300B. In this unlocked position, trough members 300A, 300B can be removed from coupler 100.

The other locking elements 107B, 107C function in a manner similar to that of locking elements 107A, 407A.

### IV. Method of Use

An example method for coupling one or both of trough members 300A, 300B to coupler 100 is as follows. Locking element 407A is positioned in the unlocked position so that points 219 of U-shaped member 210 are located so that trough members 300A, 300B can be inserted into spacing 103 of coupler 100. See, for example, FIG. 13. Terminal end 302 of trough member 300A is then inserted into spacing 103 of coupler 100 in direction B. When trough member 300A is fully inserted into coupler 100, handle portion 220 of locking element 407A is rotated in the clockwise direction to move U-shaped member 210 transversely so that point 219 contacts slot 310 of trough member 300A. See, for example, FIG. 12. In this locked position, point 219 engages slot 310 of trough member 300A to resist movement of trough member 300A out of coupler 100. Trough member 300B can be coupled to second coupler end 111 of coupler 100 in a similar manner.

An example method of removing trough member 300A includes rotating handle member 220 of locking element 407A in the counterclockwise direction to move U-shaped member 210 transversely so that point 219 moves away from slot 310 of trough member 300A. Once point 219 disengages slot 310, trough member 300A can be removed from spacing 103 of coupler 100. Trough member 300B can be removed in a similar fashion.

In example embodiments, locking element 107A or 407A can be coupled to coupler 100 during manufacture of coupler 100 so that the user need not couple locking elements 107A, 407A to coupler 100. In other embodiments, locking elements 107A, 407A can be coupled to coupler 100 by the user as desired after manufacture of coupler 100.

In example embodiments, the locking elements disclosed herein are tool-less in that the locking elements do not require a separate tool to move the locking elements from the locked position to the unlocked position and vice versa. For example, in some embodiments, the locking elements can be moved from the locked position to the unlocked position through use of the user's hand.

Alternative embodiments to those provided herein are also possible. For example, in one alternative embodiment, a coupler can be configured to be coupled to more than two trough members, therefore including more than the first and second coupler ends. Further, a greater number of locking elements can be presented for each coupler end, or, alternatively, fewer locking elements such as, for example, two on opposing sides, can be used.

In other embodiments, the locking elements can be coupled at different positions on the coupler to engage difference portions of the trough members. For example, in alternative embodiments, the locking elements can be positioned to engage the exterior surface of the trough members. Other configurations are possible.

The above specification, examples and data provide a complete description of the manufacture and of the invention. Since many embodiments of the invention can be made without departing from the spirit and scope of the disclosure, the invention resides in the claims hereinafter appended.

What is claimed is:

1. A locking element for a coupler of a cable trough system, the locking element comprising:
a handle member defining an outer circumference configured to allow a user to grasp and turn the handle member;
a threaded member; and
a member including first and second arms each defining points, the member defining an aperture sized to receive the threaded member;
wherein the threaded member is coupled to the coupler, and the user grasps the outer circumference of the handle member and rotates the handle member to move the member in a first direction to cause at least one of the first and second arms of the member to contact an exterior surface of a trough member of the cable trough system to lock the trough member to the coupler.

2. The locking element of claim 1, wherein the handle member is rotated to move the member in a second direction opposite to that of the first direction to cause the at least one of the first and second arms of the member to release the exterior surface the trough member of the cable trough system to unlock the trough member from the coupler.

3. The locking element of claim 1, wherein the threaded member is coupled to the coupler, and the handle member is threaded onto the threaded member.

4. The locking element of claim 1, wherein the threaded member is coupled to the handle member, and the threaded member is threaded into an aperture defined by the coupler.

5. The locking element of claim 1, further comprising a spring positioned to engage the member to force the member against the handle member, and wherein the member is U-shaped.

6. The locking element of claim 1, wherein the handle member defines a plurality of ribs on the outer circumference of the handle member.

7. A coupler for a cable trough system, the coupler comprising:
a body including a bottom wall and two side walls defining a trough, the body having a body terminal end defining an overlap region, the overlap region being sized to slideably receive a terminal end of a trough member along a longitudinal direction of the body; and
a first locking element coupled to the coupler, the first locking element including a handle member defining an outer circumference configured to allow a user to grasp and turn the handle member, a threaded member, and a U-shaped member including first and second arms each defining points, the U-shaped member defining an aperture sized to receive the threaded member;
wherein, when the first trough member is inserted into the coupler, the user grasps the outer circumference of the handle member and rotates the handle member to move the U-shaped member in a first direction to cause one of the first and second arms of the U-shaped member to contact an exterior surface of the trough member to lock the trough member in the coupler.

8. A cable trough system, comprising:
a first trough member including a terminal end and an exterior surface;
a coupler including a body including a bottom wall and two side walls defining a trough, the body having a body terminal end defining an overlap region, the overlap region being sized to slideably receive the terminal end of the first trough member along a longitudinal direction of the body; and
a first locking element coupled to the coupler, the first locking element including a handle member defining an outer circumference configured to allow a user to grasp and turn the handle member, a threaded member, and a U-shaped member including first and second arms each defining points, the U-shaped member defining an aperture sized to receive the threaded member;
wherein, when the first trough member is inserted into the coupler, the user grasps the outer circumference of the handle member and rotates the handle member to move the U-shaped member in a first direction to cause one of the first and second arms of the U-shaped member to contact the exterior surface of the first trough member to lock the first trough member in the coupler.

9. The system of claim 8, wherein the handle member is rotated to move the U-shaped member in a second direction opposite to that of the first direction to cause the one of the first and second arms of the U-shaped member to release the exterior surface the first trough member to unlock the first trough member from the coupler.

10. The system of claim 8, wherein the threaded member is coupled to the coupler, and the handle member is threaded onto the threaded member.

11. The system of claim 8, wherein the threaded member is coupled to the handle member, and the threaded member is threaded into an aperture defined by the coupler.

12. The system of claim 8, further comprising a spring positioned between the U-shaped member and the coupler to force the U-shaped member against the handle member.

13. The system of claim 8, further comprising a second trough member including an exterior surface, wherein the second trough member is inserted into the coupler, the handle member is rotated to move the U-shaped member in the first direction to cause another one of the first and second arms of the U-shaped member to contact the exterior surface of the second trough member to lock the second trough member in the coupler.

14. The system of claim 8, wherein the exterior surface of the first trough member that is contacted by the one of the first and second arms of the U-shaped member is a slot defined by the exterior surface of the first trough member.

15. The system of claim 8, wherein the handle member defines ribs on the outer circumference of the handle member.

16. A method for coupling a coupler to a trough member, the method comprising:
inserting a trough member including into the coupler;
grasping an outer surface of a handle member of a locking element, the outer surface defining a plurality of ribs configured to enhance a user's grasp of the handle member; and
rotating the handle member of the locking element to move a U-shaped member in a first direction to cause one of first and second arms of the U-shaped member to contact an exterior surface of the first trough member to lock the first trough member to the coupler.

17. The method of claim 16, further comprising:
rotating the handle member to move the U-shaped member in a second direction opposite to that of the first direction to cause the one of the first and second arms of the U-shaped member to release the exterior surface the first trough member to unlock the trough member from the coupler; and
sliding the trough member out of the coupler.

18. The method of claim 16, further comprising positioning a spring between the U-shaped member and the coupler to force the U-shaped member away from the coupler.
